(19) United States
(12) Patent Application Publication
(10) Pub. No.: US 2025/0286983 A1
(43) Pub. Date: Sep. 11, 2025

(54) PROJECTION APPARATUS, PROJECTION SYSTEM, CONTROL METHOD, AND CONTROL PROGRAM

(71) Applicant: FUJIFILM Corporation, Tokyo (JP)

(72) Inventors: Kazuki INOUE, Saitama-shi (JP); Kazuki ISHIDA, Saitama-shi (JP); Masahiko MIYATA, Saitama-shi (JP)

(73) Assignee: FUJIFILM Corporation, Tokyo (JP)

(21) Appl. No.: 19/214,891

(22) Filed: May 21, 2025

Related U.S. Application Data
(63) Continuation of application No. PCT/JP2023/038516, filed on Oct. 25, 2023.

(30) Foreign Application Priority Data
Nov. 25, 2022 (JP) 2022-188693

(51) Int. Cl. H04N 9/31

(52) U.S. Cl. CPC H04N 9/3185; H04N 9/3147; H04N 9/3188

(57) ABSTRACT

A first projection apparatus (1(2)0A) including a projection portion (124), a control device (121), and a first communication portion (122) is capable of forming a transmission path with at least one another second projection apparatus (1(2)0B). The projection portion (124) projects a partial image of a projection image to a first projection region (7a). In a case where the first communication portion (122) receives an enlarging or reducing instruction of the first projection region (7a) including an enlarging or reducing ratio, the control device (121) calculates at least any of a direction or an amount of shifting of the first projection region (7a) based on the enlarging or reducing ratio and on positional information related to a position of the partial image in the projection image.

### CROSS REFERENCE TO RELATED APPLICATION

This is a continuation of International Application No. PCT/JP2023/038516 filed on Oct. 25, 2023, and claims priority from Japanese Patent Application No. 2022-188693 filed on Nov. 25, 2022, the entire disclosures of which are incorporated herein by reference.

### BACKGROUND OF THE INVENTION

### 1. Field of the Invention

The present invention relates to a projection apparatus, a projection system, a control method, and a storage medium storing a control program.

### 2. Description of the Related Art

JP2018-050144A discloses a projection system comprising an image supply device and a plurality of projectors A to C, in which the image supply device and the projector A, the projectors A and B, and the projectors B and C are connected in a daisy chain through an HDMI (registered trademark) cable, the projector A that is a master device transmits image data received from the image supply device and a control signal to the projectors B and C that are slave devices connected to a downstream side, and the control signal includes projection range information of each projector and information related to edge blending processing required for tiling projection.

JP2005-274937A discloses a multi-screen video reproduction apparatus in which one large screen is composed of a combination of a plurality of display devices such as projectors (by tiling), and a control state (zoom/tele-wide switching, lens shift, and the like) of an optical system of each display device can be individually set.

JP2019-095633A discloses a multi-projection system composed of a master projector and one or more slave projectors, in which the master projector, during optical shifting, performs edge blending correction on an input image based on an optical shift amount and transmits the optical shift amount to the slave projector, and the slave projector performs edge blending correction and image cutout based on the optical shift amount.

### SUMMARY OF THE INVENTION

One embodiment according to the disclosed technology provides a projection apparatus, a projection system, a control method, and a control program capable of accurately adjusting a relative projection position among a plurality of projection apparatuses.
(1)

A projection apparatus comprises a projection portion, a processor, and a first communication portion, in which the projection apparatus is capable of forming a transmission path with at least one another projection apparatus, the projection portion projects a partial image of a projection image to a first projection region, and the processor is configured to, in response to the first communication portion receiving an enlarging or reducing instruction of a projection region including an enlarging or reducing ratio, calculate at least any of a direction or an amount of shifting of the first projection region based on the enlarging or reducing ratio and on positional information related to a position of the partial image in the projection image.
(2)

The projection apparatus according to (1) further comprises a second communication portion, in which the first communication portion receives the enlarging or reducing instruction from a front stage of the projection apparatus in the transmission path, and the processor is configured to perform a control of transmitting an instruction including the enlarging or reducing instruction to a rear stage of the projection apparatus in the transmission path from the second communication portion.
(3)

In the projection apparatus according to (1) or (2), the processor is configured to control the projection portion to execute enlarging or reducing of the first projection region based on the enlarging or reducing instruction and shifting of the first projection region based on at least any of the calculated direction or the calculated amount of shifting.
(4)

In the projection apparatus according to any one of (1) to (3), the first projection region has an overlapping part with a projection region of the other projection apparatus forming the transmission path, and the processor is configured to calculate at least any of the direction or the amount of shifting of the first projection region such that a ratio of the overlapping part in the first projection region is maintained before and after enlarging or reducing and shifting the first projection region based on the enlarging or reducing instruction.
(5)

In the projection apparatus according to any one of (1) to (4), the processor is configured to calculate the direction of shifting based on the positional information.
(6)

In the projection apparatus according to any one of (1) to (5), the processor is configured to calculate the amount of shifting based on the enlarging or reducing ratio and on the positional information.
(7)

In the projection apparatus according to any one of (1) to (6), the enlarging or reducing instruction includes an enlarging or reducing center, and the processor is configured to calculate at least any of the direction or the amount of shifting of the first projection region based on the enlarging or reducing center.
(8)

In the projection apparatus according to any one of (1) to (7), the first communication portion receives instruction information related to projection, including an instruction value and type information of the instruction value, and the processor is configured to control projection of the projection portion based on the type information and on the instruction value.
(9)

In the projection apparatus according to any one of (1) to (8), the processor is configured to, in a case where shifting of the first projection region by the calculated amount of shifting is unavailable in the projection portion, control the projection portion to execute shifting of the first projection region of an amount available in the projection portion and enlarging or reducing of the first projection region corresponding to shifting of the first projection region of the amount available in the projection portion.
(10)

In the projection apparatus according to (9), the processor is configured to, in a case where shifting of the first projection region by the calculated amount of shifting is unavailable in the projection portion, perform a control of transmitting information related to the enlarging or reducing ratio of the projection region corresponding to shifting of the first projection region of the amount available in the projection portion to the other projection apparatus forming the transmission path.
(11)

In the projection apparatus according to (10), the processor is configured to, in response to information related to an enlarging or reducing ratio different from the enlarging or reducing ratio of the enlarging or reducing instruction being received from the other projection apparatus forming the transmission path, control the projection portion to execute enlarging or reducing and shifting of the first projection region based on the information related to the different enlarging or reducing ratio.
(12)

In the projection apparatus according to any one of (1) to (8), the processor is configured to, in a case where shifting of the first projection region based on the enlarging or reducing instruction is unavailable, control the projection portion not to execute enlarging or reducing and shifting of the first projection region.
(13)

In the projection apparatus according to (12), the processor is configured to perform a control of transmitting information related to availability of shifting of the first projection region based on the enlarging or reducing instruction to the other projection apparatus forming the transmission path, and in response to a projection apparatus that is unavailable to perform shifting of the projection region based on the enlarging or reducing instruction being present among other projection apparatuses forming the transmission path based on the information related to the availability of shifting of the projection region based on the enlarging or reducing instruction and received from the other projection apparatuses forming the transmission path, control the projection portion not to execute enlarging or reducing and shifting of the first projection region.
(14)

In the projection apparatus according to any one of (1) to (13), the enlarging or reducing instruction includes an instruction for shifting resulting from enlarging or reducing of the projection region, and the processor is configured to calculate at least any of the direction or the amount of shifting of the first projection region based on the instruction for shifting.
(15)

A projection system comprises a projection apparatus included in a plurality of projection apparatuses capable of forming a transmission path, and a control device capable of transmitting projection image data representing a projection image and instruction information related to projection through the transmission path, in which a first projection apparatus included in the plurality of projection apparatuses projects a partial image of the projection image to a first projection region and, in response to an enlarging or reducing instruction of a projection region including an enlarging or reducing ratio being received, calculates at least any of a direction or an amount of shifting of the first projection region based on the enlarging or reducing ratio and on positional information related to a position of the partial image in the projection image.
(16)

In the projection system according to (15), the control device is capable of transmitting the instruction information by issuing an interrupt during transmission of the projection image data.
(17)

In the projection system according to (15), the control device transmits the instruction information by issuing an interrupt in accordance with a transmission state of the projection image data being transmitted.
(18)

A control method of a projection apparatus including a projection portion, a processor, and a first communication portion and being capable of forming a transmission path with at least one another projection apparatus, the projection portion projecting a partial image of a projection image to a first projection region, comprises calculating, in response to the first communication portion receiving an enlarging or reducing instruction of a projection region including an enlarging or reducing ratio, at least any of a direction or an amount of shifting of the first projection region via the processor based on the enlarging or reducing ratio and on positional information related to a position of the partial image in the projection image.
(19)

A non-transitory computer-readable storage medium storing a control program of a projection apparatus including a projection portion, a processor, and a first communication portion and being capable of forming a transmission path with at least one another projection apparatus, the projection portion projecting a partial image of a projection image to a first projection region, causes the processor to execute a process comprising calculating, in response to the first communication portion receiving an enlarging or reducing instruction of a projection region including an enlarging or reducing ratio, at least any of a direction or an amount of shifting of the first projection region based on the enlarging or reducing ratio and on positional information related to a position of the partial image in the projection image. According to the present invention, a projection apparatus, a projection system, a control method, and a storage medium storing a control program capable of accurately adjusting a relative projection position among a plurality of projection apparatuses can be provided.

### BRIEF DESCRIPTION OF THE DRAWINGS

FIG. 1 is a diagram illustrating an example of a projection system 100 of the present embodiment.

FIG. 2 is a diagram illustrating an example of an internal configuration of a projection apparatus 120.

FIG. 3 is a schematic diagram illustrating an exterior configuration of the projection apparatus 120.

FIG. 4 is a schematic cross-sectional view of an optical unit 106 of the projection apparatus 120 illustrated in FIG. 3.

FIG. 5 is a diagram illustrating an example of a hardware configuration of a computer 110.

FIG. 6 is a flowchart illustrating an example of processing of the projection apparatus 120.

FIG. 7 is a diagram illustrating a state where only enlarging processing of a first projection region 7a and a second projection region 7b is performed in a first example of enlarging processing of a projection region.

FIG. 8 is a diagram illustrating a state where shift processing of the first projection region 7a and the second projection region 7b is performed from the state illustrated in FIG. 7.

FIG. 9 is a diagram illustrating a state where only enlarging processing of the first projection region 7a and the second projection region 7b is performed in a second example of the enlarging processing of the projection region.

FIG. 10 is a diagram illustrating a state where shift processing of the first projection region 7a and the second projection region 7b is performed from the state illustrated in FIG. 9.

FIG. 11 is a flowchart illustrating an example of processing of the computer 110.

FIG. 12 is a flowchart illustrating a first modification example of the processing of the projection apparatus 120.

FIG. 13 is a flowchart illustrating a second modification example of the processing of the projection apparatus 120.

FIG. 14 is a diagram illustrating an example of an error message displayed on a screen 6 in a case where an enlarging control corresponding to an enlarging instruction cannot be performed.

FIG. 15 is a schematic diagram illustrating another exterior configuration of the projection apparatus 120.

FIG. 16 is a schematic cross-sectional view of the optical unit 106 of the projection apparatus 120 illustrated in FIG. 15.

### DESCRIPTION OF THE PREFERRED EMBODIMENTS

Hereinafter, an example of an embodiment of the present invention will be described with reference to the drawings.

### Projection System 100 of Embodiment

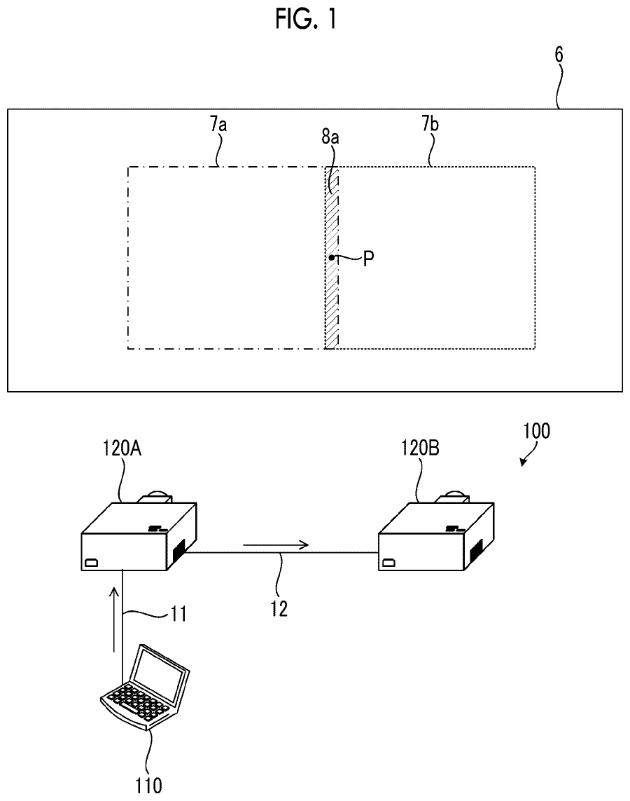

FIG. 1 is a diagram illustrating an example of a projection system 100 of the present embodiment. As illustrated in FIG. 1, the projection system 100 comprises a plurality of projection apparatuses (in the present example, a first projection apparatus 120A and a second projection apparatus 120B) and a computer 110 that controls the first projection apparatus 120A and the second projection apparatus 120B. While the present example illustrates a configuration including two projection apparatuses, the number of projection apparatuses is not limited. The computer 110 is an example of a control device according to the embodiment of the present invention.

The first projection apparatus 120A and the second projection apparatus 120B are apparatuses capable of projecting an image to, for example, a screen 6 that is a projection target object. Each of the first projection apparatus 120A and the second projection apparatus 120B projects a partial image constituting a projection image (the whole image) to be displayed on the screen 6. One projection image displayed on the screen 6 is an image generated by arranging two partial images projected by the first projection apparatus 120A and the second projection apparatus 120B.

The first projection apparatus 120A and the second projection apparatus 120B are connected in a daisy chain to be capable of communicating with the computer 110 through a communication line. The first projection apparatus 120A is connected to the computer 110 through a communication line 11. The second projection apparatus 120B is connected to the first projection apparatus 120A through a communication line 12. The first projection apparatus 120A and the second projection apparatus 120B may be able to perform bidirectional daisy chain communication or may be able to perform communication using a communication path (for example, a wireless network or a wired network) provided separately from a daisy chain.

Hereinafter, a projection apparatus connected to the computer 110 among the plurality of projection apparatuses connected to the computer 110 for control in a daisy chain will be referred to as a master projection apparatus. In the daisy chain connection, a projection apparatus connected to a side close to the computer 110 will be referred to as a projection apparatus of a front stage side, and a projection apparatus connected to a side far from the computer 110 will be referred to as a projection apparatus of a rear stage side. In the present example, the first projection apparatus 120A is the master projection apparatus. The first projection apparatus 120A is the projection apparatus of the front stage side, and the second projection apparatus 120B is the projection apparatus of the rear stage side.

The computer 110 can transmit projection image data to the first projection apparatus 120A and the second projection apparatus 120B through a serial transmission path formed by the first projection apparatus 120A and the second projection apparatus 120B connected in a daisy chain. The computer 110 generates partial image data obtained by dividing the projection image data and transmits the partial image data to the first projection apparatus 120A and the second projection apparatus 120B through the serial transmission path. The projection image data is image data reproduced by arranging the partial image data. The partial image data is arranged such that the partial images represented by the respective partial image data have parts overlapping with each other.

The screen 6 is a projection target object having a projection surface on which the partial images projected by the first projection apparatus 120A and the second projection apparatus 120B are displayed. In the example illustrated in FIG. 1, the projection surface of the screen 6 is a rectangular surface. The projection target object is not limited to a rectangular screen and may be, for example, a wall surface of a building.

In the example illustrated in FIG. 1, the screen 6 has a first projection region 7a and a second projection region 7b corresponding to the first projection apparatus 120A and the second projection apparatus 120B, respectively. The first projection region 7a and the second projection region 7b are disposed in a left-to-right direction on the screen 6. The first projection region 7a indicated by a dot-dashed line is a region in which the partial image projected by the first projection apparatus 120A is displayed. The second projection region 7b indicated by a broken line is a region in which the partial image projected by the second projection apparatus 120B is displayed.

The projection system 100, for example, displays a laterally long projection image on the screen 6 by projecting the partial image from the first projection apparatus 120A to the first projection region 7a, projecting the partial image from the second projection apparatus 120B to the second projection region 7b, and connecting the two partial images. The projection system 100 performs the projection by causing the first projection region 7a and the second projection region 7b to partially overlap with each other. In the example illustrated in FIG. 1, an overlapping part 8a indicated by diagonal lines is a region in which the first projection region 7a and the second projection region 7b overlap with each other.

In displaying the laterally long projection image by connecting the first projection region 7a and the second projection region 7b as two partial images as described above, the projection system 100 performs overlapping processing of generating two partial images such that the respective overlapping parts of the first projection region 7a and the second projection region 7b are the same image. In a case where an enlarging or reducing instruction (an instruction to enlarge or reduce) or the like for the projection image is provided from a user, the projection system 100 performs shift adjustment of a relative position between the first projection region 7a and the second projection region 7b such that, for example, a ratio of an area of the overlapping part 8a to an area of the projection image remains constant before and after enlarging or reducing processing. The relative position between the first projection region 7a and the second projection region 7b is a position of the second projection region 7b relative to the first projection region 7a.

### Internal Configuration of Projection Apparatus 120

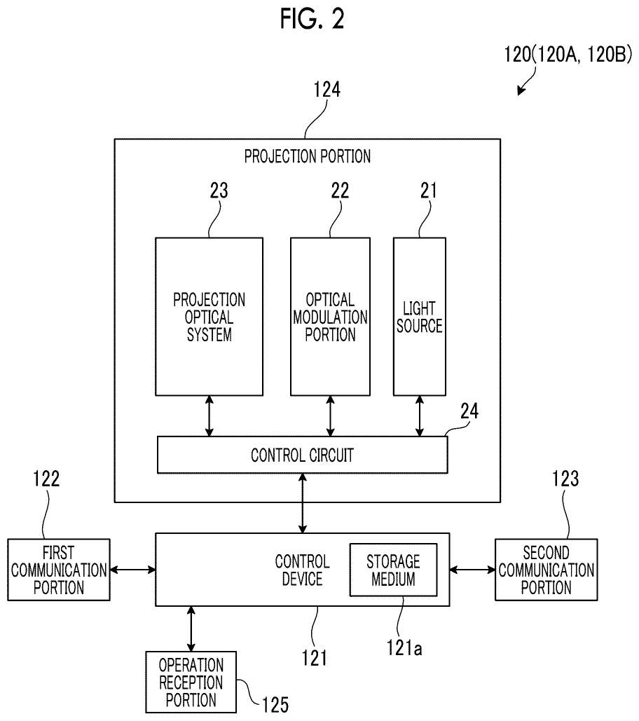

FIG. 2 is a diagram illustrating an example of an internal configuration of a projection apparatus 120. The projection apparatus 120 includes the first projection apparatus 120A and the second projection apparatus 120B. As illustrated in FIG. 2, the projection apparatus 120 comprises a control device 121, a first communication portion 122, a second communication portion 123, a projection portion 124, and an operation reception portion 125. The control device 121 is an example of a processor according to the embodiment of the present invention.

The control device 121 controls projection in the projection apparatus 120. The control device 121 is a device including a control portion composed of various processors, a communication interface (not illustrated) for communicating with each portion, and a storage medium 121a such as a hard disk, a solid state drive (SSD), or a read only memory (ROM) and controls the projection portion 124 in an integrated manner. The various processors of the control portion in the control device 121 include, for example, a central processing unit (CPU) that is a general-purpose processor performing various types of processing by executing a program, a programmable logic device (PLD) such as a field programmable gate array (FPGA) that is a processor having a circuit configuration changeable after manufacture, or a dedicated electric circuit such as an application specific integrated circuit (ASIC) that is a processor having a circuit configuration dedicatedly designed to execute specific processing.

More specifically, structures of the various processors are electric circuits obtained by combining circuit elements such as semiconductor elements. The control portion in the control device 121 may be composed of one of the various processors or may be composed of a combination of two or more processors of the same type or different types (for example, a combination of a plurality of FPGAs or a combination of a CPU and an FPGA).

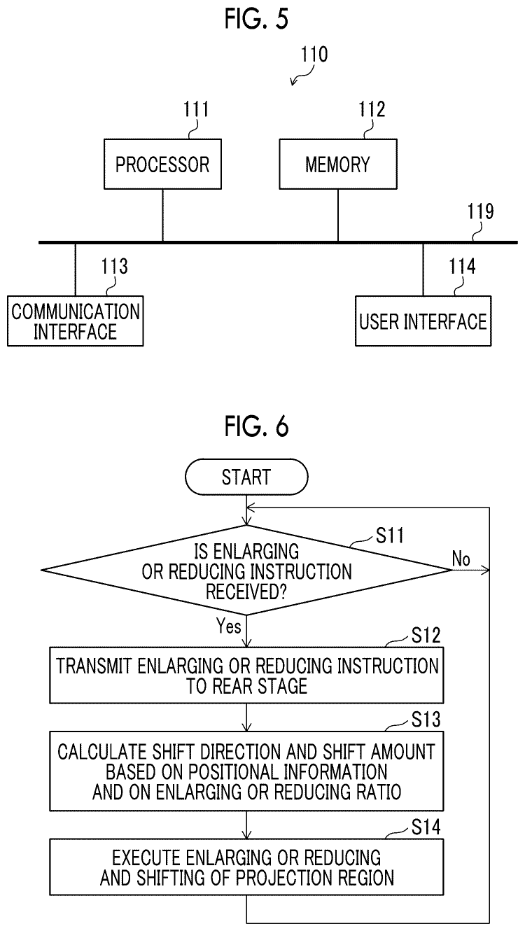

The first communication portion 122 is an interface that can communicate with other projection apparatuses disposed on the front stage side among the plurality of projection apparatuses connected in a daisy chain or with the computer for control. For example, in the configuration illustrated in FIG. 1, in a case where the apparatus of the first communication portion 122 is the second projection apparatus 120B, the first communication portion 122 is connected to the second communication portion 123 of the first projection apparatus 120A disposed on the front stage side of the second projection apparatus 120B through the communication line 12. In the configuration illustrated in FIG. 1, in a case where the apparatus of the first communication portion 122 is the first projection apparatus 120A that is the master projection apparatus, the first communication portion 122 is connected to a communication interface 113 (refer to FIG. 5) of the computer 110 through the communication line 11.

The second communication portion 123 is an interface that can communicate with other projection apparatuses disposed on the rear stage side among the plurality of projection apparatuses connected in a daisy chain. For example, in the configuration illustrated in FIG. 1, in a case where the apparatus of the second communication portion 123 is the first projection apparatus 120A, the second communication portion 123 is connected to the first communication portion 122 of the second projection apparatus 120B disposed on the rear stage side of the first projection apparatus 120A through the communication line 12. In the configuration illustrated in FIG. 1, in a case where the apparatus of the second communication portion 123 is the second projection apparatus 120B, there is no projection apparatus connected on the rear stage side. Thus, the second communication portion 123 is in a non-connected state. The first communication portion 122 and the second communication portion 123 may be wired communication interfaces that perform wired communication as illustrated in FIG. 1, or may be wireless communication interfaces that perform wireless communication.

The projection portion 124 is composed of, for example, a liquid crystal projector or a projector using liquid crystal on silicon (LCOS). Hereinafter, the projection portion 124 will be described as a liquid crystal projector. The projection portion 124 comprises a light source 21, an optical modulation portion 22, a projection optical system 23, and a control circuit 24.

The light source 21 includes a light emitting element such as a laser or a light emitting diode (LED) and emits, for example, white light.

The optical modulation portion 22 is composed of three liquid crystal panels (optical modulation elements) that emit each color image by modulating, based on image information, each color light emitted from the light source 21 and separated into three colors of red, blue, and green by a color separation mechanism (not illustrated), and a dichroic prism that combines each color image emitted from the three liquid crystal panels and emits the combined color image in the same direction. Each color image may be emitted by mounting filters of red, blue, and green in each of the three liquid crystal panels and modulating the white light emitted from the light source 21 via each liquid crystal panel.

Light from the light source 21 and the optical modulation portion 22 is incident on the projection optical system 23. The projection optical system 23 includes at least one lens and is composed of, for example, a relay optical system. Light that has passed through the projection optical system 23 is projected to the screen 6.

In the screen 6, a region irradiated with light transmitted through the whole range of the optical modulation portion 22 is a projectable range in which projection can be performed by the projection portion 124. In the projectable range, a region irradiated with light actually transmitted from the optical modulation portion 22 is a projection range (the first projection region 7a and the second projection region 7b) of the projection portion 124. For example, a size, a position, and a shape of the projection range (the first projection region 7a and the second projection region 7b) of the projection portion 124 in the projectable range are changed by controlling a size, a position, and a shape of a region through which light is transmitted in the optical modulation portion 22.

The control circuit 24 projects the partial images based on the partial image data to the first projection region 7a and the second projection region 7b of the screen 6 by controlling the light source 21, the optical modulation portion 22, and the projection optical system 23 based on the partial image data input from the control device 121. The partial image data input into the control circuit 24 is composed of three pieces of data including red display data, blue display data, and green display data.

The control circuit 24 enlarges or reduces and moves the projection range of the projection portion 124 by changing the projection optical system 23 based on an instruction input from the control device 121. For example, the instruction input from the control device 121 may be an instruction based on an external instruction operation of the user received by the operation reception portion 125 or may be an instruction based on an input instruction operation of the computer 110 received by the first communication portion 122.

The projection apparatus 120 comprises a shift mechanism that mechanically or optically moves the projection range of the projection portion 124 while maintaining an image circle of the projection optical system 23. The image circle of the projection optical system 23 is a region in which projection light incident on the projection optical system 23 correctly passes through the projection optical system 23 in terms of light fall-off, color separation, edge part curvature, and the like.

The shift mechanism is implemented by at least any of an optical system shift mechanism that performs optical system shifting or an electronic shift mechanism that performs electronic shifting.

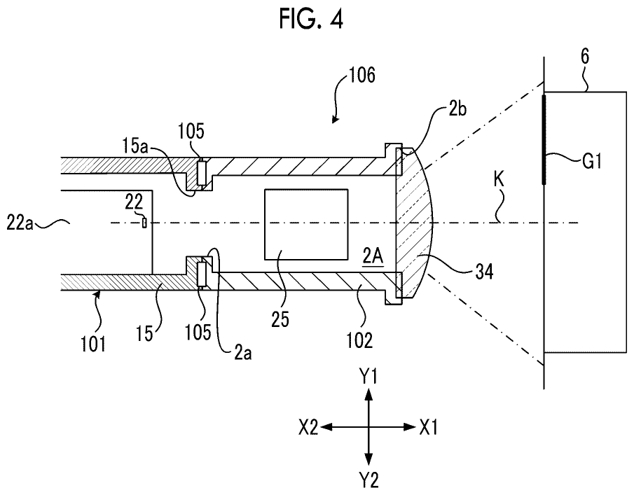

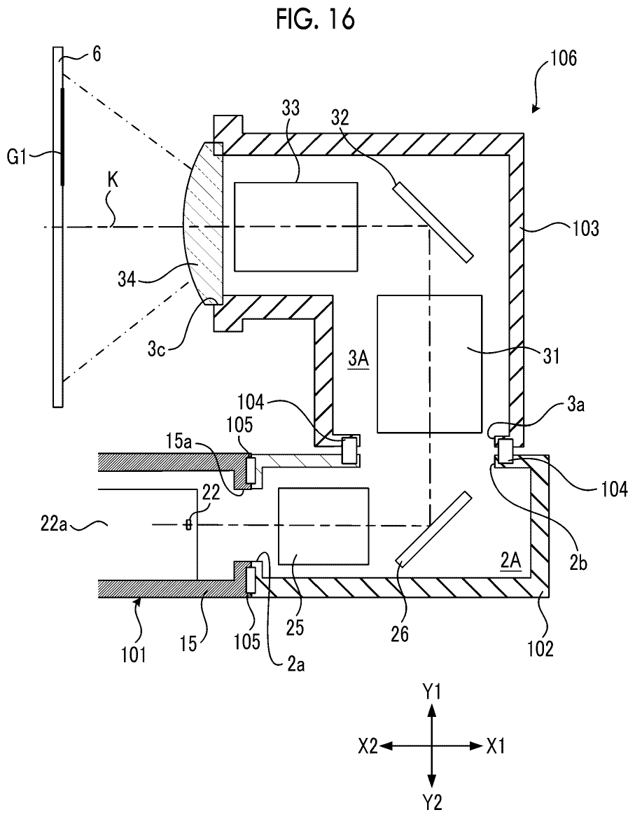

The optical system shift mechanism is, for example, a mechanism (for example, refer to FIGS. 4 and 16) that moves the projection optical system 23 in a direction perpendicular to an optical axis, or a mechanism that moves the optical modulation portion 22 in the direction perpendicular to the optical axis instead of moving the projection optical system 23. The optical system shift mechanism may perform the movement of the projection optical system 23 and the movement of the optical modulation portion 22 in combination.

The electronic shift mechanism is a mechanism that performs pseudo shifting of the projection range by changing a range through which light is transmitted in the optical modulation portion 22.

The projection apparatus 120 may comprise a projection direction changing mechanism that moves the projection range together with the image circle of the projection optical system 23. The projection direction changing mechanism is a mechanism that changes a projection direction of the projection portion 124 by changing a direction of the projection portion 124 via mechanical rotation (for example, refer to FIG. 16).

The relative position between the first projection region 7a and the second projection region 7b can be adjusted by, for example, moving at least any of the first projection region 7a or the second projection region 7b using the shift mechanism or the projection direction changing mechanism.

The operation reception portion 125 detects an instruction from the user (a user instruction) by receiving various operations from the user. The operation reception portion 125 may be a button, a key, a joystick, or the like provided in the control device 121 or may be a reception portion or the like that receives a signal from a remote controller for remotely operating the control device 121.

The projection portion 124, the control device 121, and the operation reception portion 125 are implemented by, for example, a single device. The projection portion 124, the control device 121, and the operation reception portion 125 may be separate devices that cooperate with each other through communication.

### Mechanical Configuration of Projection Apparatus 120

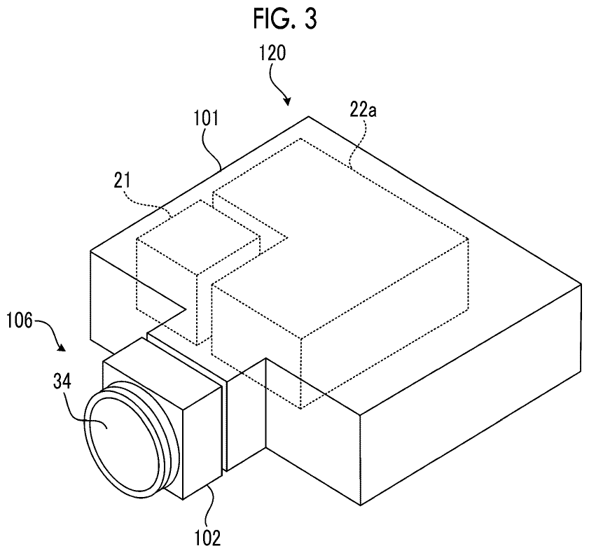

FIG. 3 is a schematic diagram illustrating an exterior configuration of the projection apparatus 120. FIG. 4 is a schematic cross-sectional view of an optical unit 106 of the projection apparatus 120 illustrated in FIG. 3. FIG. 4 illustrates a cross section in a plane along an optical path of light emitted from a body part 101 illustrated in FIG. 3. The projection apparatus 120 includes the first projection apparatus 120A and the second projection apparatus 120B.

As illustrated in FIG. 3, the projection apparatus 120 comprises the body part 101 and the optical unit 106 provided to protrude from the body part 101. In the configuration illustrated in FIG. 3, the operation reception portion 125; the control device 121; the light source 21, the optical modulation portion 22, and the control circuit 24 in the projection portion 124; and the first communication portion 122 and the second communication portion 123 are provided in the body part 101. The projection optical system 23 in the projection portion 124 is provided in the optical unit 106.

The optical unit 106 comprises a first member 102 supported by the body part 101. The optical unit 106 may be configured to be attachable to and detachable from the body part 101 (in other words, configured to be interchangeable).

As illustrated in FIG. 4, the body part 101 includes a housing 15 in which an opening 15a for allowing light to pass is formed in a part connected to the optical unit 106.

As illustrated in FIG. 3, the light source 21 and an optical modulation unit 22a including the optical modulation portion 22 (refer to FIG. 2) that generates an image by spatially modulating light emitted from the light source 21 based on input image data are provided in the housing 15 of the body part 101. Light emitted from the light source 21 is incident on the optical modulation portion 22 of the optical modulation unit 22a and is spatially modulated and emitted by the optical modulation portion 22.

As illustrated in FIG. 4, the image formed by the light spatially modulated by the optical modulation unit 22a is incident on the optical unit 106 through the opening 15a of the housing 15 and is projected to the screen 6. Accordingly, an image G1 is visible from an observer.

As illustrated in FIG. 4, the optical unit 106 comprises the first member 102 having a hollow portion 2A connected to the inside of the body part 101, a first optical system 25 disposed in the hollow portion 2A, a lens 34, and a first shift mechanism 105.

The first member 102 is a member having, for example, a rectangular cross-sectional exterior, in which an opening 2a and an opening 2b are formed in surfaces parallel to each other. The first member 102 is supported by the body part 101 in a state where the opening 2a is disposed at a position facing the opening 15a of the body part 101. Light emitted from the optical modulation portion 22 of the optical modulation unit 22a of the body part 101 is incident into the hollow portion 2A of the first member 102 through the opening 15a and the opening 2a.

An incidence direction of the light incident into the hollow portion 2A from the body part 101 will be referred to as a direction X1. A direction opposite to the direction X1 will be referred to as a direction X2. The direction X1 and the direction X2 will be collectively referred to as a direction X. A front-to-back direction of FIG. 4 and a direction opposite thereto will be referred to as a direction Z. In the direction Z, the front-to-back direction will be referred to as a direction Z1, and the back-to-front direction will be referred to as a direction Z2. A direction perpendicular to the direction X and to the direction Z will be referred to as a direction Y. In the direction Y, an upward direction in FIG. 4 will be referred to as a direction Y1, and a downward direction in FIG. 4 will be referred to as a direction Y2. In the example in FIG. 4, the projection apparatus 120 is disposed such that the direction Y2 is a vertical direction.

The projection optical system 23 illustrated in FIG. 2 is composed of the first optical system 25 and the lens 34 in the example in FIG. 4. FIG. 4 illustrates an optical axis K of the projection optical system 23. The first optical system 25 and the lens 34 are disposed in this order from a side closer to the optical modulation portion 22 along the optical axis K.

The first optical system 25 includes at least one lens and guides light that is incident on the first member 102 from the body part 101 and that travels in the direction X1, to the lens 34.

The lens 34 is disposed in an end part of the first member 102 on a side in the direction X1 in the form of closing the opening 2b formed in the end part. The lens 34 projects light incident from the first optical system 25 to the screen 6.

The first shift mechanism 105 is a mechanism for moving the optical axis K of the projection optical system 23 (in other words, the optical unit 106) in a direction (the direction Y in FIG. 4) perpendicular to the optical axis K. Specifically, the first shift mechanism 105 is configured to change a position of the first member 102 in the direction Y with respect to the body part 101. The first shift mechanism 105 may manually move the first member 102 or electrically move the first member 102.

FIG. 4 illustrates a state where the first member 102 is moved as far as possible to the side in the direction Y1 by the first shift mechanism 105. By moving the first member 102 in the direction Y2 via the first shift mechanism 105 from the state illustrated in FIG. 4, a relative position between a center of the image (in other words, a center of a display surface) formed by the optical modulation portion 22 and the optical axis K changes, and the image G1 projected to the screen 6 can be shifted (translated) in the direction Y2. The first shift mechanism 105 may be a mechanism that moves the optical modulation portion 22 in the direction Y instead of moving the optical unit 106 in the direction Y. Even in this case, the image G1 projected to the screen 6 can be moved in the direction Y.

### Hardware Configuration of Computer 110

FIG. 5 is a diagram illustrating an example of a hardware configuration of the computer 110. As illustrated in FIG. 5, the computer 110 illustrated in FIG. 1 comprises a processor 111, a memory 112, the communication interface 113, and a user interface 114. The processor 111, the memory 112, the communication interface 113, and the user interface 114 are connected to each other through, for example, a bus 119.

The processor 111 is a circuit performing signal processing and is, for example, a CPU that controls the whole computer 110. The processor 111 may be implemented by other digital circuits such as an FPGA and a digital signal processor (DSP). The processor 111 may be implemented by a combination of a plurality of digital circuits.

The memory 112 includes, for example, a main memory and an auxiliary memory. The main memory is, for example, a random access memory (RAM). The main memory is used as a work area of the processor 111.

The auxiliary memory is, for example, a non-volatile memory such as a magnetic disk, an optical disc, or a flash memory. The auxiliary memory stores various programs for operating the computer 110. The programs stored in the auxiliary memory are loaded into the main memory and executed by the processor 111.

The auxiliary memory may include a portable memory that can be detached from the computer 110. Examples of the portable memory include a universal serial bus (USB) flash drive, a memory card such as a secure digital (SD) memory card, and an external hard disk drive.

The communication interface 113 is a communication interface that communicates with the outside of the computer 110 (for example, the first projection apparatus 120A). The communication interface 113 is controlled by the processor 111. The communication interface 113 may be a wired communication interface performing wired communication or a wireless communication interface performing wireless communication or may include both of the wired communication interface and the wireless communication interface.

The user interface 114 includes, for example, an input device that receives an operation input from the user, and an output device that outputs information to the user. The input device can be implemented by, for example, a pointing device (for example, a mouse), a key (for example, a keyboard), or a remote controller. The output device can be implemented by, for example, a display or a speaker. The input device and the output device may be implemented by a touch panel or the like. The user interface 114 is controlled by the processor 111.

Processing of Control Device 121 of Projection Apparatus 120

For example, in a case where the first communication portion 122 receives the enlarging or reducing instruction including an enlarging or reducing ratio for the first projection region 7a and the second projection region 7b, the control device 121 calculates shift directions and shift amounts of the first projection region 7a and the second projection region 7b based on the enlarging or reducing ratio and on positional information related to positions of the partial images in the projection image. The positional information of the partial images is stored in the storage medium 121a of the control device 121 as two-dimensional information on X and Y axes on the screen 6.

In the serial transmission path consisting of, for example, the first projection apparatus 120A and the second projection apparatus 120B connected in a daisy chain, in a case where the first communication portion 122 receives the enlarging or reducing instruction from a front stage of the projection apparatus, the control device 121 performs a control of transmitting an instruction including the enlarging or reducing instruction to a rear stage of the projection apparatus from the second communication portion 123. The front stage of the projection apparatus includes the computer 110 and other projection apparatuses. The rear stage of the projection apparatus includes other projection apparatuses.

The control device 121 controls the projection portion 124 to execute enlarging or reducing of the first projection region 7a and the second projection region 7b based on the enlarging or reducing instruction and shifting of the first projection region 7a and the second projection region 7b based on the calculated shift directions and the calculated shift amounts. The control device 121 may execute enlarging or reducing and shifting at the same time.

The control device 121 calculates the shift directions and the shift amounts of the first projection region 7a and the second projection region 7b such that the ratio of the overlapping part 8a between the first projection region 7a and the second projection region 7b is maintained before and after enlarging or reducing and shifting the first projection region 7a and the second projection region 7b based on the enlarging or reducing instruction.

The control device 121 calculates the shift directions of the first projection region 7a and the second projection region 7b based on the positional information related to the positions of the partial images in the projection image. For example, it is assumed that the first projection region 7a and the second projection region 7b are displayed in a lateral two-tile display as illustrated in FIG. 1, the first projection region 7a and the second projection region 7b are enlarged using a center point of the projection image (the whole image) as an enlarging or reducing center P, and a host projection apparatus is performing projection to a left side of the screen 6 in a front view. In this case, the control device 121 calculates shifting in a left direction. For example, it is assumed that nine projection regions are displayed in a 3×3 (three rows in a lateral direction and three rows in a longitudinal direction) display, enlarging is performed using the center point of the projection image (the whole image) as the enlarging or reducing center P, like the enlarging or reducing center P in FIG. 1, and the host projection apparatus is performing projection to the upper left. In this case, the control device 121 calculates shifting in an upper left direction.

The control device 121 calculates the shift amounts of the first projection region 7a and the second projection region 7b based on the enlarging or reducing ratio for the first projection region 7a and the second projection region 7b and on the positional information of the partial images in the projection image. For example, the shift amounts are increased as the enlarging or reducing ratio is increased. For example, the shift amounts are increased as a distance from the enlarging or reducing center in the projection image (the whole image) is increased.

In enlarging or reducing the first projection region 7a and the second projection region 7b, the control device 121 calculates the shift directions and the shift amounts of the first projection region 7a and the second projection region 7b based on the enlarging or reducing center provided by an instruction in the projection image (the whole image). While the “enlarging or reducing center” is, for example, the center of the projection image (the whole image), the enlarging or reducing center may be a lower right corner or the like of the projection image. In a case where an instruction to set the enlarging or reducing center at the lower right of the projection image is provided, the first projection region 7a and the second projection region 7b are enlarged toward the upper left in a case where enlarging is performed, and are reduced toward the lower right in a case where reducing is performed. The shift directions are directions away from the enlarging or reducing center or directions close to the enlarging or reducing center. The shift amounts are increased as the distance from the enlarging or reducing center is increased.

In the serial transmission path consisting of, for example, the first projection apparatus 120A and the second projection apparatus 120B connected in a daisy chain, in a case where the first communication portion 122 receives instruction information related to projection, including an instruction value and type information of the instruction value, the control device 121 controls projection of the projection portion 124 based on the type information and on the instruction value.

For example, a state where the computer 110 transmits a command (1200, A1, 0, 700, A2, 600, 1200, Focus, A1, +1, A2−1) as the instruction information related to projection is assumed. 1200 means size information of the projection image (the whole image). A1 and A2 mean information indicating a number of the projection apparatus. 0 and 700 mean information indicating a start point and an end point of a projection position of the projection apparatus of A1. 600 and 1200 mean information indicating a start point and an end point of a projection position of the projection apparatus of A2. Focus means information indicating a type to be operated. A1 of A1 and +1 means a flag indicating adjustment of focus of the projection apparatus of A1, and +1 means an instruction value indicating an adjustment amount of the focus. A2 of A2 −1 means a flag indicating adjustment of focus of the projection apparatus of A2, and −1 means an instruction value indicating an adjustment amount of the focus. Next, for example, it is assumed that the user performs an instruction operation of adjusting only the focus of the projection apparatus of A1 by −1. In this case, the computer 110 may transmit, for example, a command (Focus, A1, −1) as the instruction information related to projection. Focus means the information indicating the type to be operated. A1 of A1 and −1 means the flag indicating adjustment of the focus of the projection apparatus of A1, and −1 means the instruction value indicating the adjustment amount of the focus. In this way, the computer 110 may transmit only the instruction information for a point to be changed through adjustment. In a case where the command is received on the projection apparatus side, the projection apparatus detects the type to be adjusted by determining the flag. For a type that is not received, the projection apparatus maintains an adjustment state based on the instruction value of the instruction information received so far. Limiting the instruction information to be transmitted to only data related to the point to be changed can achieve compression of information.

In a case where shifting of the first projection region 7a or the second projection region 7b by the calculated shift amount is unavailable in the projection portion 124 of the first projection apparatus 120A or the projection portion 124 of the second projection apparatus 120B, the control device 121 controls the projection portion 124 to execute shifting of the first projection region 7a and the second projection region 7b of an amount available in each projection portion 124 and enlarging or reducing of the first projection region 7a and the second projection region 7b corresponding to the available shift amount. In a case where the shift amount of the projection portion 124 is insufficient, the control device 121 performs an enlarging or reducing control corresponding to the available shift amount.

In a case where shifting of the first projection region 7a and the second projection region 7b by the calculated shift amounts is unavailable in the projection portion 124 of the first projection apparatus 120A or the projection portion 124 of the second projection apparatus 120B, the control device 121 performs a control of transmitting information related to the enlarging or reducing ratio of the first projection region 7a and the second projection region 7b corresponding to shifting of the first projection region 7a and the second projection region 7b of an amount available in each projection portion 124 to another projection apparatuses forming the transmission path. For example, the “information related to the enlarging or reducing ratio of the first projection region 7a and the second projection region 7b” transmitted to the other projection apparatus may be an enlarging or reducing ratio that is different from the enlarging or reducing ratio provided by the enlarging or reducing instruction and with which the host projection apparatus can perform enlarging or reducing, or may be information about the host projection apparatus enabling calculation of the enlarging or reducing ratio with which the host projection apparatus can perform enlarging or reducing.

In a case where the control device 121 receives the information related to the enlarging or reducing ratio different from the enlarging or reducing ratio of the enlarging or reducing instruction from the other projection apparatus forming the transmission path, the control device 121 controls the projection portion 124 to execute enlarging or reducing and shifting of the first projection region 7a and the second projection region 7b based on the information related to the different enlarging or reducing ratio. For example, in a case where another projection apparatus that cannot perform shifting using the enlarging or reducing ratio provided by an instruction is present, the control device 121 performs enlarging or reducing and shifting corresponding to an amount by which the projection apparatus can perform shifting. In a case where a plurality of projection apparatuses that cannot perform shifting are present, the control device 121 may perform enlarging or reducing and shifting corresponding to a projection apparatus having the smallest amount of change in enlarging or reducing (having no margin for shifting).

The control device 121 performs a control of transmitting information related to availability of shifting of the first projection region 7a and the second projection region 7b based on the enlarging or reducing instruction to the other projection apparatus forming the transmission path. In a case where a projection apparatus that is unavailable to perform shifting of the first projection region 7a and the second projection region 7b based on the enlarging or reducing instruction is present among other projection apparatuses forming the transmission path based on the information related to the availability of shifting of the first projection region 7a and the second projection region 7b based on the enlarging or reducing instruction and received from other projection apparatuses forming the transmission path, the control device 121 controls the projection portion not to execute enlarging or reducing and shifting of the first projection region 7a and the second projection region 7b. The “information related to the availability of shifting” may be, for example, information indicating that “shifting (enlarging or reducing) can be performed” or information indicating that “shifting (enlarging or reducing) cannot be performed”. In a case where the information indicates that “shifting (enlarging or reducing) can be performed”, the control device 121 of each projection apparatus, for example, may execute enlarging or reducing and shifting in a case where the information indicating that “shifting (enlarging or reducing) can be performed” is received from all of the other projection apparatuses. In a case where the information indicates that “shifting (enlarging or reducing) cannot be performed”, the control device 121 of each projection apparatus, for example, may execute enlarging or reducing and shifting in a case where the information indicating that “shifting (enlarging or reducing) cannot be performed” is not received from the other projection apparatus within a certain amount of time from a time at which the enlarging or reducing instruction is provided.

In a case where the first communication portion 122 receives the enlarging or reducing instruction including a shift instruction resulting from enlarging or reducing of the projection region, the control device 121 calculates the shift direction and the shift amount of the first projection region 7a or the second projection region 7b based on the shift instruction resulting from enlarging or reducing of the projection region. For example, the enlarging or reducing instruction including the shift instruction resulting from enlarging or reducing of the projection region is the enlarging or reducing instruction including an instruction for the shift direction in a case where a direction in which the projection region is shifted is provided by an instruction from the user.

Processing of Computer 110

In a case where, for example, an instruction operation from the user is performed during transmission of the projection image data to the first projection apparatus 120A and the second projection apparatus 120B, the computer 110 transmits the instruction information to the projection apparatus by issuing an interrupt in accordance with a transmission state of the projection image data being transmitted. The instruction operation includes, for example, pressing an enlarging/reducing button for enlarging or reducing the projection image. The transmission state of the projection image data indicates how much amount of data of the non-transmitted projection image data is remaining at a time at which the instruction operation is performed in the projection image data indicating one projection image.

Processing Example of Projection Apparatus

FIG. 6 is a flowchart illustrating an example of processing of the projection apparatus 120. In the present example, it is assumed that the first projection apparatus 120A and the second projection apparatus 120B are connected to the computer 110 in the state illustrated in FIG. 1. The first projection apparatus 120A and the second projection apparatus 120B receive the partial image data transmitted from the computer 110 and display the projection image (the whole image) by projecting the respective partial images represented by the partial image data to the first projection region 7a and the second projection region 7b on the screen 6. In this state, for example, it is assumed that an enlarging or reducing operation of enlarging or reducing the projection image is performed by the user through the keyboard of the computer 110. In a case where the enlarging or reducing operation is performed, a signal of the enlarging or reducing instruction for enlarging or reducing the projection region is transmitted to the first projection apparatus 120A from the computer 110 through the communication line 11. First, the control device 121 of the first projection apparatus 120A determines whether or not the enlarging or reducing instruction is received (step S11). The control device 121 receives the signal of the enlarging or reducing instruction through the first communication portion 122.

In step S11, in a case where the enlarging or reducing instruction is not received (step S11: No), the control device 121 repeats the processing in step S11. In step S11, in a case where the enlarging or reducing instruction is received (step S11: Yes), the control device 121 transmits the enlarging or reducing instruction to the second projection apparatus 120B on the rear stage (step S12). The control device 121 transmits the signal of the enlarging or reducing instruction to the second projection apparatus 120B through the second communication portion 123.

Next, the control device 121 calculates the shift direction and the shift amount of the first projection region 7a based on the positional information related to the position of the partial image in the projection image and on the enlarging or reducing ratio included in the enlarging or reducing instruction (step S13).

Next, the control device 121 executes a control of enlarging or reducing and shifting the first projection region 7a based on the shift direction and the shift amount calculated in step S13 (step S14).

The second projection apparatus 120B that receives the signal of the enlarging or reducing instruction from the first projection apparatus 120A executes the same processing as the present processing, calculates the shift direction and the shift amount of the second projection region 7b, and executes enlarging or reducing and shifting of the second projection region 7b. The control device 121 of the second projection apparatus 120B receives the signal of the enlarging or reducing instruction from the first projection apparatus 120A through the first communication portion 122.

As described above, the control device 121 of the first projection apparatus 120A of the present example calculates the shift direction and the shift amount of the first projection region 7a based on the enlarging or reducing instruction including the enlarging or reducing ratio of the projection region received by the first communication portion 122 and on the positional information of the partial image in the projection image, causes the projection portion 124 to enlarge or reduce and shift the first projection region 7a, and transmits the enlarging or reducing instruction to the second projection apparatus 120B from the second communication portion 123. Accordingly, the first projection region 7a of the first projection apparatus 120A can be appropriately enlarged or reduced and shifted, and a relative projection position between the first projection apparatus 120A and the second projection apparatus 120B can be accurately adjusted.

First Example of Enlarging Processing of Projection Region

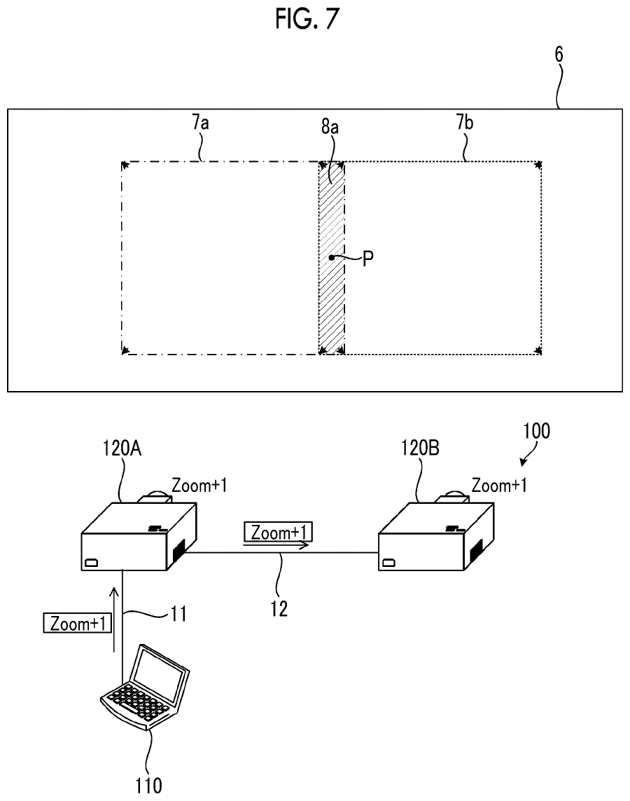

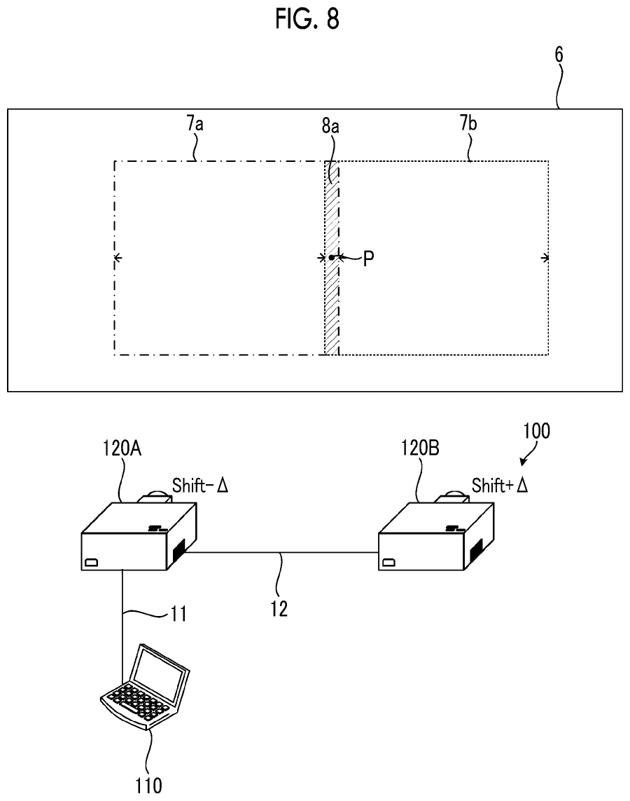

A first example of enlarging processing of the first projection region 7a and the second projection region 7b via the first projection apparatus 120A and the second projection apparatus 120B will be described with reference to FIGS. 7 and 8. The first example of the enlarging processing is processing of enlarging the first projection region 7a and the second projection region 7b using the center point of the projection image as the enlarging or reducing center P.

FIG. 7 is a diagram illustrating a state where only the enlarging processing of the first projection region 7a and the second projection region 7b is performed in the first example of the enlarging processing of the projection region. As illustrated in FIG. 7, for example, a command (Zoom+1) for enlarging the projection region by +1 is transmitted to the first projection apparatus 120A from the computer 110. The same command (Zoom+1) is transmitted to the second projection apparatus 120B from the first projection apparatus 120A. The first projection apparatus 120A performs processing of enlarging the first projection region 7a in an up-to-down direction and the left-to-right direction based on the enlarging ratio included in the enlarging or reducing instruction. The second projection apparatus 120B performs processing of enlarging the second projection region 7b in the up-to-down direction and the left-to-right direction based on the same enlarging ratio.

In a state where only the enlarging processing of the first projection region 7a and the second projection region 7b is performed, for example, a ratio of the area of the overlapping part 8a to an area of the first projection region 7a or a ratio of the area of the overlapping part 8a to an area of the second projection region 7b changes (increases) compared to that in a state before performing the enlarging processing (for example, the state illustrated in FIG. 1). Thus, in a state where only the enlarging processing of the first projection region 7a and the second projection region 7b is performed, the projection image projected to the first projection region 7a and the second projection region 7b is an image in which an image of the overlapping part 8a between the partial image projected to the first projection region 7a and the partial image projected to the second projection region 7b is distorted.

FIG. 8 is a diagram illustrating a state where shift processing of the first projection region 7a and the second projection region 7b is performed from the state illustrated in FIG. 7. As illustrated in FIG. 8, the first projection apparatus 120A calculates the shift direction and the shift amount (for example, Shift−Δ) of the first projection region 7a such that the ratio of the overlapping part 8a to the first projection region 7a is maintained before and after enlarging and shifting, based on information about the enlarging ratio and the enlarging or reducing center P included in the enlarging or reducing instruction and on the positional information of the partial images in the projection image. The second projection apparatus 120B calculates the shift direction and the shift amount (for example, Shift+Δ) of the second projection region 7b such that the ratio of the overlapping part 8a is maintained before and after enlarging and shifting, based on the same enlarging ratio, the enlarging or reducing center P, and the positional information.

The first projection apparatus 120A performs processing of shifting the first projection region 7a via the projection portion 124 based on the calculated shift direction and the calculated shift amount. The second projection apparatus 120B performs processing of shifting the second projection region 7b via the projection portion 124 based on the calculated shift direction and the calculated shift amount. As in the present example, in a case where the first projection region 7a and the second projection region 7b are displayed in a lateral two-tile display, the first projection region 7a is shifted to the left in the front view of the screen 6 with respect to the second projection region 7b. The second projection region 7b is shifted to the right in the front view of the screen 6 with respect to the first projection region 7a. By performing the shift processing of the first projection region 7a and the second projection region 7b, the ratio of the overlapping part 8a is maintained before and after enlarging or reducing and shifting of the first projection region 7a and the second projection region 7b based on the enlarging or reducing instruction. Accordingly, the image formed by two enlarged partial images projected to the first projection region 7a and the second projection region 7b is a normalized enlarged projection image.

The control device 121 of the first projection apparatus 120A in the present example causes the projection portion 124 to execute enlarging or reducing and shifting of the first projection region 7a by calculating the shift direction and the shift amount of the first projection region 7a such that the ratio of the overlapping part 8a to the first projection region 7a is maintained before and after enlarging and shifting. Accordingly, the first projection region 7a can be appropriately enlarged or reduced and shifted, and the relative projection position between the first projection apparatus 120A and the second projection apparatus 120B can be accurately adjusted.

The present example describes a case where the first projection apparatus 120A and the second projection apparatus 120B separately perform the enlarging processing and the shift processing of the first projection region 7a and the second projection region 7b. However, for example, the enlarging processing and the shift processing may be performed at the same time. Accordingly, a state where the image of the overlapping part 8a between the first projection region 7a and the second projection region 7b is temporarily distorted by performing only the enlarging processing can be prevented from standing out. While the present example illustrates a case of shifting the first projection region 7a by, for example, −1Δ and shifting the second projection region 7b by, for example, −1Δ in shifting the first projection region 7a and the second projection region 7b, the present invention is not limited to this. For example, only the first projection region 7a may be shifted by −2Δ, or only the second projection region 7b may be shifted by +2Δ. In this case, which of the projection regions is to be shifted by 2Δ may be set in advance, or the computer 110 may provide an instruction for the projection region to be shifted. While the present example illustrates a case where the ratio of the overlapping part 8a is maintained before and after enlarging or reducing and shifting of the first projection region 7a and the second projection region 7b, the present invention is not limited to this. For example, two projection regions may be brought exactly adjacent to each other such that the overlapping part 8a and a gap are not generated between the first projection region 7a and the second projection region 7b, and the direction and the amount of shifting may be calculated such that the relationship of adjacency is maintained before and after enlarging or reducing and shifting.

Second Example of Enlarging Processing of Projection Region

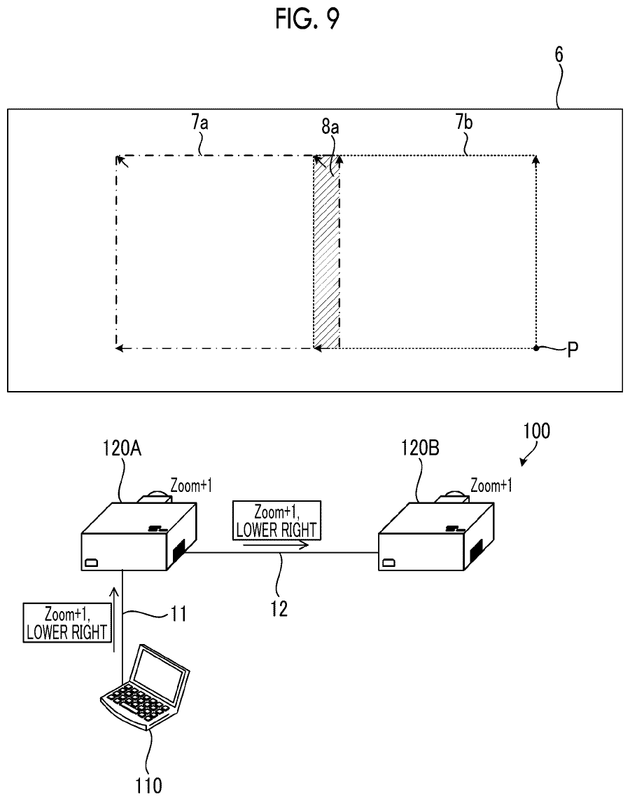

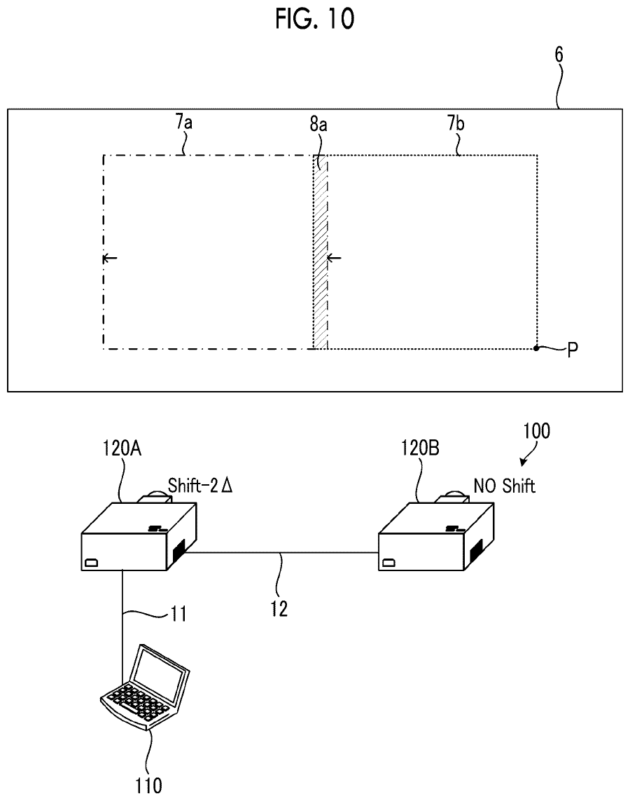

A second example of the enlarging processing of the first projection region 7a and the second projection region 7b via the first projection apparatus 120A and the second projection apparatus 120B will be described with reference to FIGS. 9 and 10. The second example of the enlarging processing is processing of enlarging the first projection region 7a and the second projection region 7b using a lower right point of the projection image as the enlarging or reducing center P.

FIG. 9 is a diagram illustrating a state where only the enlarging processing of the first projection region 7a and the second projection region 7b is performed in the second example of the enlarging processing of the projection region. As illustrated in FIG. 9, for example, a command (Zoom+1, lower right) for enlarging the projection region by +1 by setting the enlarging or reducing center P at the lower right is transmitted to the first projection apparatus 120A from the computer 110. The same command (Zoom+1, lower right) is transmitted to the second projection apparatus 120B from the first projection apparatus 120A. The first projection apparatus 120A performs processing of enlarging the first projection region 7a in the upward direction and a leftward direction based on the enlarging ratio included in the enlarging or reducing instruction. The second projection apparatus 120B performs processing of enlarging the second projection region 7b in the upward direction and the leftward direction based on the same enlarging ratio.

Even in the present example, in a state where only the enlarging processing of the first projection region 7a and the second projection region 7b is performed, for example, the ratio of the area of the overlapping part 8a to the area of the first projection region 7a or the ratio of the area of the overlapping part 8a to the area of the second projection region 7b changes (increases) compared to that in a state before performing the enlarging processing (for example, the state illustrated in FIG. 1). Thus, even in the present example, the projection image projected to the first projection region 7a and the second projection region 7b is an image in which the image of the overlapping part 8a between the partial image projected to the first projection region 7a and the partial image projected to the second projection region 7b is distorted.

FIG. 10 is a diagram illustrating a state where shift processing of the first projection region 7a and the second projection region 7b is performed from the state illustrated in FIG. 9. As illustrated in FIG. 10, the first projection apparatus 120A calculates the shift direction and the shift amount (for example, Shift−2Δ) of the first projection region 7a such that the ratio of the overlapping part 8a to the first projection region 7a is maintained before and after enlarging and shifting, based on the information about the enlarging ratio and the enlarging or reducing center P included in the enlarging or reducing instruction and on the positional information of the partial images in the projection image. Meanwhile, the second projection apparatus 120B includes a position of the enlarging or reducing center P in the second projection region 7b of the host projection apparatus, and shifting the second projection region 7b moves the position of the enlarging or reducing center P. Thus, the second projection apparatus 120B calculates the shift amount of the second projection region 7b as 0.

The first projection apparatus 120A performs processing of shifting the first projection region 7a via the projection portion 124 based on the calculated shift direction and the calculated shift amount. As in the present example, in a case where the first projection region 7a and the second projection region 7b are displayed in a lateral two-tile display, the first projection region 7a is shifted to the left in the front view of the screen 6 with respect to the second projection region 7b. Meanwhile, the second projection apparatus 120B does not shift the second projection region 7b and maintains the position of the second projection region 7b. By performing the shift processing of the first projection region 7a and the second projection region 7b, the ratio of the overlapping part 8a is maintained before and after enlarging or reducing and shifting of the first projection region 7a and the second projection region 7b based on the enlarging or reducing instruction. Accordingly, the image formed by two enlarged partial images projected to the first projection region 7a and the second projection region 7b is a normalized enlarged projection image.

According to the control device 121 of the first projection apparatus 120A in the present example, even in a case where the position of the enlarging or reducing center P is not a position of the center point of the projection image (refer to FIG. 8) and is, for example, a position of the lower right point of the projection image, the first projection region 7a can be appropriately enlarged or reduced and shifted, and the relative projection position between the first projection apparatus 120A and the second projection apparatus 120B can be accurately adjusted.

### Processing Example of Computer 110

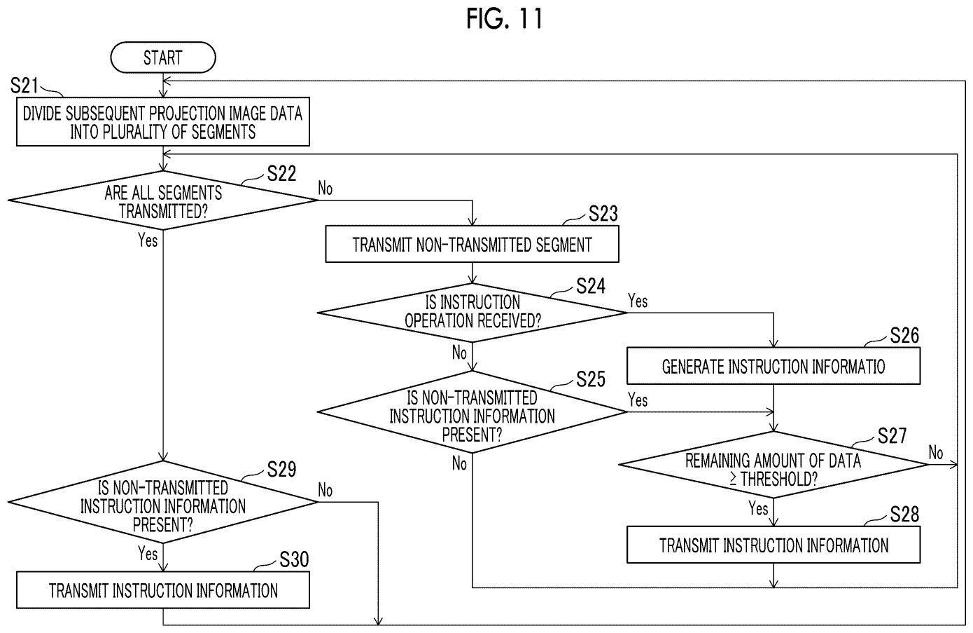

FIG. 11 is a flowchart illustrating an example of processing of the computer 110. In the present example, it is assumed that the first projection apparatus 120A and the second projection apparatus 120B are connected to the computer 110 as illustrated in FIG. 1. The computer 110 transmits the projection image data to the first projection apparatus 120A and the second projection apparatus 120B. The first projection apparatus 120A and the second projection apparatus 120B project the respective partial images represented by the partial image data to the first projection region 7a and the second projection region 7b based on the projection image data transmitted from the computer 110 and display one projection image generated by combining two partial images on the screen 6.

The computer 110 divides the subsequent projection image data to be transmitted to the first projection apparatus 120A and the second projection apparatus 120B into a plurality of segments (step S21). For example, the subsequent projection image data is the projection image data for representing one projection image to be projected to the screen 6.

Next, the computer 110 determines whether or not all segments of the image data divided in step S21 are transmitted (step S22).

In step S22, in a case where all divided segments of the image data are not transmitted (step S22: No), the computer 110 transmits one non-transmitted segment of the image data to the first projection apparatus 120A and the second projection apparatus 120B (step S23). Next, the computer 110, for example, determines whether or not the instruction operation (for example, pressing of an enlarging or reducing button) for enlarging or reducing the projection image is received during transmission of the image data in step S23 (step S24).

In step S24, in a case where the instruction operation is not received (step S24: No), the computer 110 determines whether or not non-transmitted instruction information is present (step S25). The non-transmitted instruction information is the instruction information generated in step S26 described later.

In step S25, in a case where the non-transmitted instruction information is not present (step S25: No), the computer 110 returns to step S22 and executes the processing in each step.

Meanwhile, in step S24, in a case where the instruction operation is received (step S24: Yes), the computer 110 generates the instruction information corresponding to the instruction operation (step S26). For example, in a case where the instruction operation is an operation of providing an instruction to enlarge the projection image, a command (Zoom+1) or the like is generated as the instruction information.

Next, the computer 110 determines whether or not the transmission state of the image data of the segments into which the projection image data is divided in step S21, that is, a remaining (non-transmitted) amount of data in the image data of the divided segments, is greater than or equal to a threshold value (step S27).

In step S25, even in a case where the instruction information that has not been transmitted is present (step S25: Yes), the computer 110 proceeds to step S27 and determines whether or not the remaining amount of data is greater than or equal to the threshold value.

In step S27, in a case where the remaining amount of data is greater than or equal to the threshold value (step S27: Yes), the computer 110 transmits the non-transmitted instruction information generated in step S26 to the first projection apparatus 120A and the second projection apparatus 120B (step S28). That is, in a case where the remaining amount of data is greater than or equal to the threshold value, the computer 110 executes interrupt processing of transmitting the instruction information based on the received instruction operation to the first projection apparatus 120A and the second projection apparatus 120B even in a stage in the middle of transmission in which transmission of all segments of the image data is not finished. After transmitting the instruction information, the computer 110 returns to step S22 and executes the processing in each step.

In step S27, in a case where the remaining amount of data is not greater than or equal to the threshold value (step S27: No), the computer 110 returns to step S22 and executes the processing in each step. That is, in a case where the remaining amount of data is not greater than or equal to the threshold value, the computer 110 transmits the instruction information after entering a state where transmission of all segments of the image data is finished.

Meanwhile, in step S22, in a case where all divided segments of the image data are transmitted (step S22: Yes), the computer 110 determines whether or not the non-transmitted instruction information is present (step S29).

In step S29, in a case where the non-transmitted instruction information is not present (step S29: No), the computer 110 returns to step S21 and executes the processing in each step. In step S29, in a case where the non-transmitted instruction information is present (step S29: Yes), the computer 110 transmits the instruction information to the first projection apparatus 120A and the second projection apparatus 120B (step S30). After transmitting the instruction information, the computer 110 returns to step S21 and executes the processing in each step.

As described above, in a case where the computer 110 of the present example receives the enlarging or reducing instruction for enlarging or reducing the projection region, the computer 110 transmits the instruction information based on the enlarging or reducing instruction to the first projection apparatus 120A and the second projection apparatus 120B by issuing an interrupt even in a stage in the middle of transmission of the projection image data, in a case where the transmission state of the projection image data, for example, the remaining (non-transmitted) amount of data of the projection image data representing one projection image is greater than or equal to the threshold value. This can reduce a standby state where the command related to the enlarging or reducing instruction is not transmitted until transmission of one piece of the projection image data is completed. Thus, high-speed processing can be achieved.

First Modification Example of Processing of Projection Apparatus

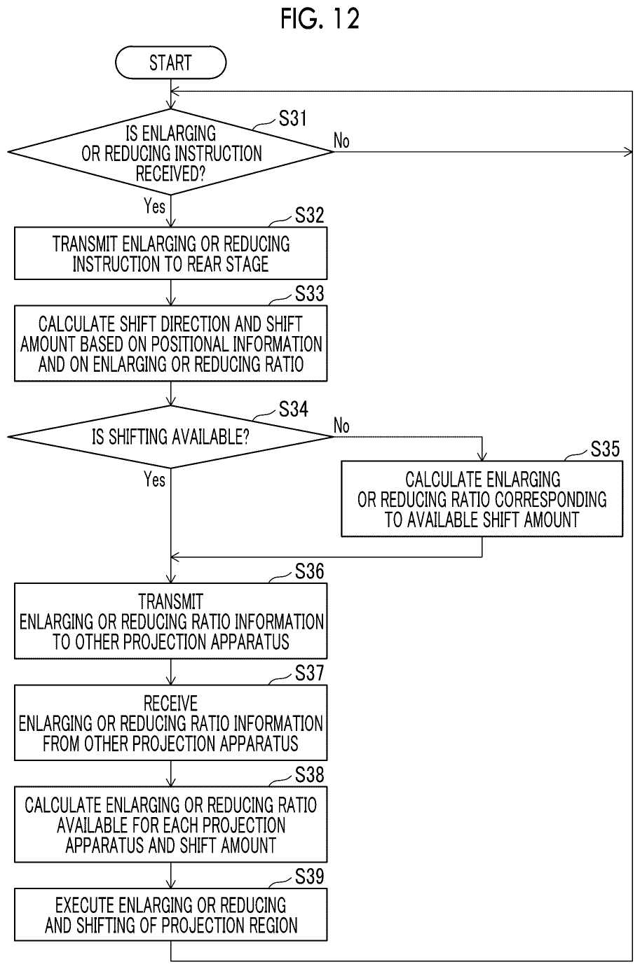

FIG. 12 is a flowchart illustrating a first modification example of the processing of the projection apparatus 120. In the present example, as in the case described with reference to FIG. 6, it is assumed that the first projection apparatus 120A and the second projection apparatus 120B are connected to the computer 110 in a daisy chain, and the signal of the enlarging or reducing instruction for enlarging or reducing the projection region is transmitted to the first projection apparatus 120A from the computer 110 through the communication line 11 by the enlarging or reducing operation of the projection image performed by the user.

As illustrated in FIG. 12, each processing in steps S31 to S33 is the same as each processing in steps S11 to S13 described with reference to FIG. 6 and thus, will not be described.

Next, the control device 121 of the first projection apparatus 120A determines whether or not shifting of the first projection region 7a by the shift direction and the shift amount calculated in step S33 is available (step S34).

In step S34, in a case where shifting of the first projection region 7a is unavailable (step S34: No), the control device 121 calculates an available shift amount for shifting the first projection region 7a via the host projection apparatus (the first projection apparatus 120A) and calculates the enlarging or reducing ratio corresponding to the shift amount (step S35).

Next, the control device 121 transmits enlarging or reducing ratio information corresponding to the shift amount calculated for the host projection apparatus in step S35 to the other projection apparatus (in the present example, the second projection apparatus 120B) (step S36).

Meanwhile, in step S34, in a case where shifting of the first projection region 7a is available (step S34: Yes), the control device 121 proceeds to step S36 and transmits the enlarging or reducing ratio information corresponding to the shift amount calculated in step S33 to the other projection apparatus (in the present example, the second projection apparatus 120B).

Next, the control device 121 receives the enlarging or reducing ratio information from the other projection apparatus (in the present example, the second projection apparatus 120B) (step S37).

Next, the control device 121 calculates the enlarging or reducing ratio with which each projection apparatus can perform enlarging or reducing, and the shift amount based on the enlarging or reducing ratio information received from the other projection apparatus (step S38). The shift direction is the same as the shift direction calculated in step S33.

Next, based on the enlarging or reducing ratio and the shift amount calculated in step S38, the control device 121 executes a control of enlarging or reducing and shifting the first projection region 7a using the enlarging or reducing ratio with which all projection apparatuses can perform enlarging or reducing, and the shift amount (step S39).

The second projection apparatus 120B executes the same processing as the present processing by receiving the signal of the enlarging or reducing instruction from the first projection apparatus 120A, and executes enlarging or reducing and shifting of the second projection region 7b. The control device 121 of the second projection apparatus 120B receives the signal of the enlarging or reducing instruction from the first projection apparatus 120A through the first communication portion 122.

For example, in a case where a projection apparatus that cannot execute shifting of the projection region using the enlarging or reducing ratio provided by the enlarging or reducing instruction is present, the control device 121 of the first projection apparatus 120A in the present example performs enlarging or reducing and shifting of the first projection region 7a using the enlarging or reducing ratio with which all projection apparatuses can perform enlarging or reducing, and the shift amount. Accordingly, enlarging or reducing and shifting of the first projection region 7a can be performed, and the relative projection position between the first projection apparatus 120A and the second projection apparatus 120B can be accurately adjusted.

### Second Modification Example of Processing of Projection Apparatus

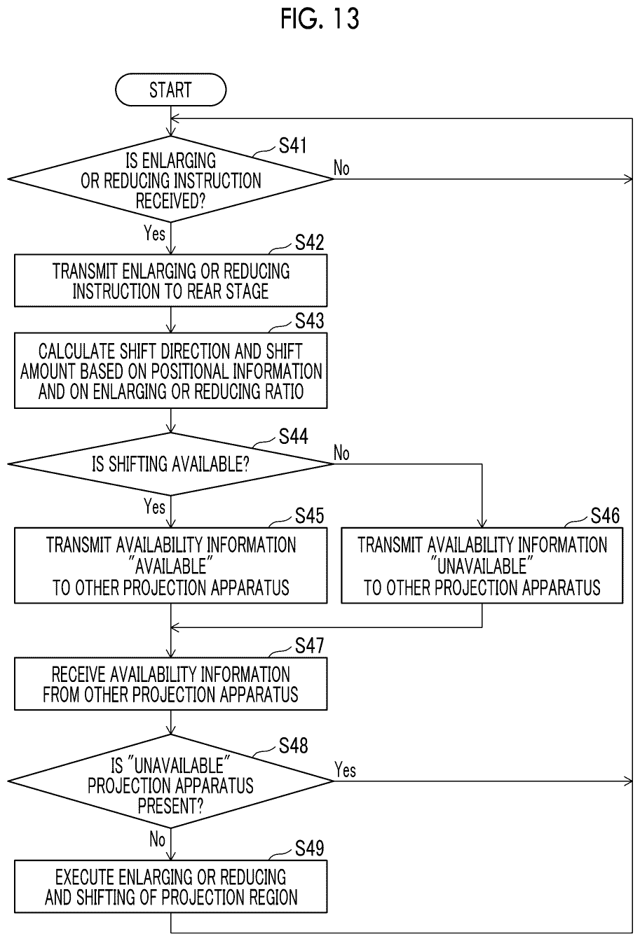

FIG. 13 is a flowchart illustrating a second modification example of the processing of the projection apparatus 120. In the present example, as in the case described with reference to FIG. 6, it is assumed that the first projection apparatus 120A and the second projection apparatus 120B are connected to the computer 110 in a daisy chain, and the signal of the enlarging or reducing instruction for enlarging or reducing the projection region is transmitted to the first projection apparatus 120A from the computer 110 through the communication line 11 by the enlarging or reducing operation of the projection image performed by the user.

As illustrated in FIG. 13, each processing in steps S41 to S43 is the same as each processing in steps S11 to S13 described with reference to FIG. 6 and thus, will not be described.

Next, the control device 121 of the first projection apparatus 120A determines whether or not shifting of the first projection region 7a using the shift direction and the shift amount calculated in step S43 is available (step S44).

In step S44, in a case where shifting of the first projection region 7a is available (step S44: Yes), the control device 121 transmits availability information “available” indicating that shifting is available, to the other projection apparatus (in the present example, the second projection apparatus 120B) (step S45).

In step S44, in a case where shifting of the first projection region 7a is unavailable (step S44: No), the control device 121 transmits availability information “unavailable” indicating that shifting is unavailable, to the other projection apparatus (in the present example, the second projection apparatus 120B) (step S46).

Next, the control device 121 receives the availability information of shifting from the other projection apparatus (in the present example, the second projection apparatus 120B) (step S47).

Next, the control device 121 determines whether or not a projection apparatus that is “unavailable” to perform shifting is present among all projection apparatuses including the host projection apparatus (step S48).

In step S48, in a case where the projection apparatus that is “unavailable” to perform shifting is not present (step S48: No), the control device 121 executes the control of enlarging or reducing and shifting the first projection region 7a based on the shift direction and the shift amount calculated in step S43 (step S49). After executing the control of enlarging or reducing and shifting, the control device 121 returns to step S41 and executes the processing in each step.

In step S48, in a case where the projection apparatus that is “unavailable” to perform shifting is present (step S48: Yes), the control device 121 returns to step S41 and executes the processing in each step. That is, in a case where the projection apparatus that is “unavailable” to perform shifting is present, the control device 121 does not execute the control of enlarging or reducing and shifting the first projection region 7a.

In a case where shifting of the first projection region 7a is unavailable, and the availability information “unavailable” is transmitted to the other projection apparatus in step S46, the control device 121 may return to step S41 and execute the processing in each step. In this case, the control device 121 determines whether or not the projection apparatus that is “unavailable” to perform shifting is present among other projection apparatuses excluding the host projection apparatus in step S48. The second projection apparatus 120B executes the same processing as the present processing by receiving the signal of the enlarging or reducing instruction from the first projection apparatus 120A, and executes enlarging or reducing and shifting of the second projection region 7b.

For example, in a case where the projection apparatus that cannot execute shifting of the projection region using the enlarging or reducing ratio provided by the enlarging or reducing instruction is present, the control device 121 of the first projection apparatus 120A in the present example does not execute the control of enlarging or reducing and shifting the first projection region 7a. Accordingly, enlarging or reducing and shifting of the first projection region 7a corresponding to the enlarging or reducing instruction can be performed, and the relative projection position between the first projection apparatus 120A and the second projection apparatus 120B can be accurately adjusted.

### Display of Error Message

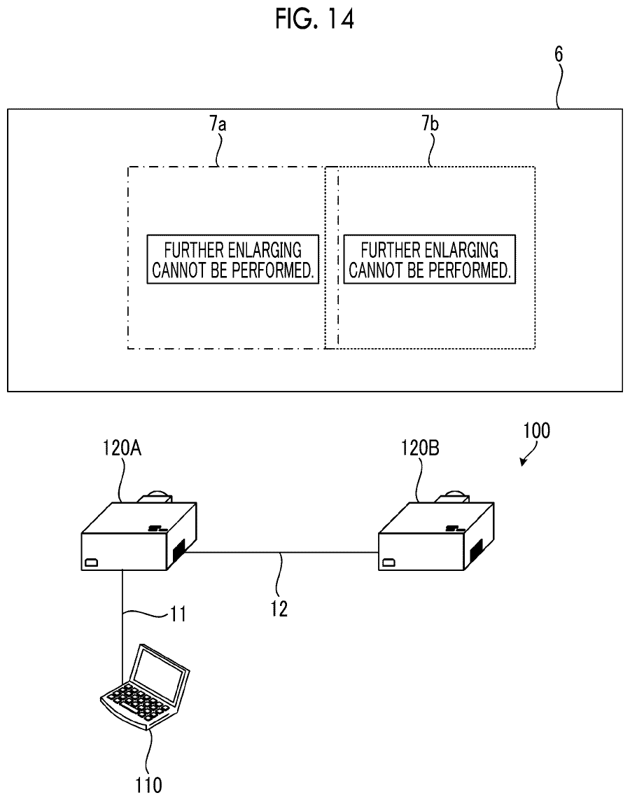

FIG. 14 is a diagram illustrating an example of an error message displayed on the screen 6 in a case where an enlarging control corresponding to an enlarging instruction cannot be performed.

In the first modification example of the processing of the projection apparatus described with reference to FIG. 12, in a case where the projection apparatus that cannot control shifting of the first projection region 7a and the second projection region 7b in accordance with the enlarging or reducing instruction is present, the control device 121 performs enlarging or reducing and shifting of the projection region using the enlarging or reducing ratio and the shift amount available for all projection apparatuses (steps S38 and S39). In this case, for example, as illustrated in FIG. 14, an error message such as “Further enlarging cannot be performed” may be displayed to provide notification indicating that the image cannot be enlarged to the size provided by the instruction.

In the second modification example of the processing of the projection apparatus described with reference to FIG. 13, in a case where the projection apparatus that cannot control shifting of the first projection region 7a and the second projection region 7b in accordance with the enlarging or reducing instruction is present, the control device 121 does not perform enlarging or reducing and shifting of the projection region (step S48: Yes). In this case, for example, as illustrated in FIG. 14, an error message such as “Further enlarging cannot be performed” may be displayed to provide notification indicating that the image cannot be enlarged.

### Modification Example of Mechanical Configuration of Projection Apparatus 120

While a configuration in which the optical axis K is not bent has been described as a configuration of the projection apparatus 120 with reference to FIGS. 3 and 4, the optical axis K may be configured to be bent once or more by providing a reflective member in the optical unit 106.

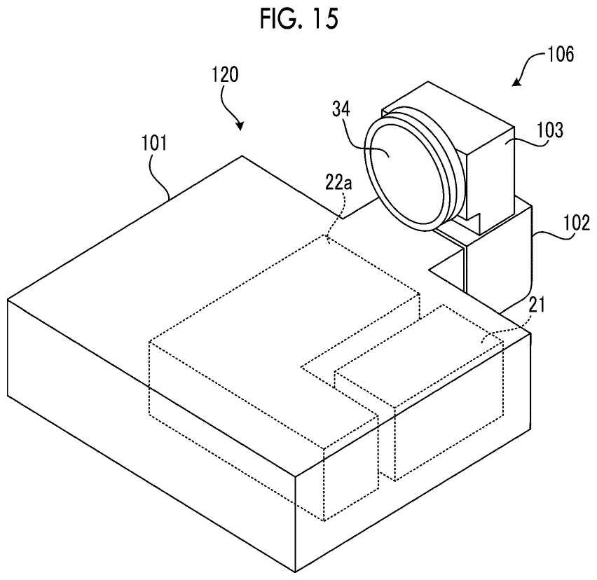

FIG. 15 is a schematic diagram illustrating another exterior configuration of the projection apparatus 120. FIG. 16 is a schematic cross-sectional view of the optical unit 106 of the projection apparatus 120 illustrated in FIG. 15. In FIGS. 15 and 16, the same parts as the parts illustrated in FIGS. 3 and 4 will be designated by the same reference numerals and will not be described.

As illustrated in FIG. 15, the optical unit 106 comprises a second member 103 supported by the first member 102, in addition to the first member 102 supported by the body part 101. The first member 102 and the second member 103 may be members integrated with each other.

As illustrated in FIG. 16, the optical unit 106 comprises, in addition to the first member 102, the second member 103 including a hollow portion 3A connected to the hollow portion 2A of the first member 102; the first optical system 25 and a reflective member 26 disposed in the hollow portion 2A; a second optical system 31, a reflective member 32, a third optical system 33, and the lens 34 disposed in the hollow portion 3A; the first shift mechanism 105; and a projection direction changing mechanism 104.

In the examples in FIGS. 15 and 16, the opening 2a and the opening 2b of the first member 102 are formed in surfaces perpendicular to each other. The projection optical system 23 illustrated in FIGS. 15 and 16 is composed of the reflective member 26, the second optical system 31, the reflective member 32, and the third optical system 33, in addition to the first optical system 25 and the lens 34 illustrated in FIGS. 3 and 4. By providing the projection optical system 23, the optical axis K is bent twice to have a folded shape, as illustrated in FIG. 16. The first optical system 25, the reflective member 26, the second optical system 31, the reflective member 32, the third optical system 33, and the lens 34 are disposed in this order from the side closer to the optical modulation portion 22 along the optical axis K.

The first optical system 25 guides light that is incident on the first member 102 from the body part 101 and that travels in the direction X1, to the reflective member 26. The reflective member 26 reflects the light incident from the first optical system 25 to the direction Y1. The reflective member 26 is composed of, for example, a mirror. In the first member 102, the opening 2b is formed on the optical path of the light reflected by the reflective member 26, and the reflected light travels to the hollow portion 3A of the second member 103 through the opening 2b.

The second member 103 is a member having an approximately L-shaped cross-sectional exterior, in which an opening 3a is formed at a position facing the opening 2b of the first member 102. Light that has passed through the opening 2b of the first member 102 from the body part 101 is incident into the hollow portion 3A of the second member 103 through the opening 3a. The first member 102 and the second member 103 may have any cross-sectional exterior and are not limited to the above.

The second optical system 31 includes at least one lens and guides the light incident from the first member 102 to the reflective member 32. The reflective member 32 guides the light incident from the second optical system 31 to the third optical system 33 by reflecting the light to the direction X2. The reflective member 32 is composed of, for example, a mirror. The third optical system 33 includes at least one lens and guides the light reflected by the reflective member 32 to the lens 34.

The lens 34 is disposed in an end part of the second member 103 on a side in the direction X2 in the form of closing an opening 3c formed in the end part. The lens 34 projects the light incident from the third optical system 33 to the screen 6.

FIG. 16 illustrates a state where the first member 102 is moved as far as possible to the side in the direction Y1 by the first shift mechanism 105. By moving the first member 102 in the direction Y2 via the first shift mechanism 105 from the state illustrated in FIG. 16, the relative position between the center of the image formed by the optical modulation portion 22 and the optical axis K changes, and the image G1 projected to the screen 6 can be shifted in the direction Y2.

The projection direction changing mechanism 104 is a rotation mechanism that rotatably connects the second member 103 to the first member 102. By providing the projection direction changing mechanism 104, the second member 103 is configured to be rotatable about a rotation axis (specifically, the optical axis K) that extends in the direction Y. The projection direction changing mechanism 104 is not limited to the disposition position illustrated in FIG. 16 as long as the projection direction changing mechanism 104 can rotate the optical system. The number of rotation mechanisms is not limited to one, and a plurality of rotation mechanisms may be provided.

The control method described in the above embodiment can be implemented by executing a control program prepared in advance via a computer. The present control program is recorded on a computer-readable storage medium and executed by reading out the control program from the storage medium. The present control program may be provided in the form of being stored in a non-transitory storage medium such as a flash memory or may be provided through a network such as the Internet. The computer that executes the present control program may be included in the control device, may be included in an electronic apparatus such as a smartphone, a tablet terminal, or a personal computer capable of communicating with the control device, or may be included in a server apparatus capable of communicating with the control device and the electronic apparatus.

While various embodiments have been described above, the present invention is not limited to such examples. Those skilled in the art may apparently perceive various modification examples or correction examples within the scope according to the claims, and those examples are also construed as falling within the technical scope of the present invention. Each constituent in the embodiment may be used in any combination thereof without departing from the gist of the invention.

The present application is based on Japanese Patent Application (JP2022-188693) filed on Nov. 25, 2022, the content of which is incorporated in the present application by reference.

### EXPLANATION OF REFERENCES

2A, 3A: hollow portion
2a, 2b, 3a, 3c, 15a: opening
6: screen
7a: first projection region
7b: second projection region
8a: overlapping part
11, 12: communication line
15: housing
21: light source
22: optical modulation portion
22a: optical modulation unit
23: projection optical system
24: control circuit
25: first optical system
26, 32: reflective member
31: second optical system
33: third optical system
34: lens
100: projection system
101: body part
102: first member
103: second member
104: projection direction changing mechanism
105: first shift mechanism
106: optical unit
110: computer
111: processor
112: memory
113: communication interface
114: user interface
119: bus
120: projection apparatus
120A: first projection apparatus
120B: second projection apparatus
121: control device
121a: storage medium
122: first communication portion
123: second communication portion
124: projection portion
125: operation reception portion
G1: image

What is claimed is:

1. A projection apparatus comprising:
a projection portion;
a processor; and
a first communication portion,
wherein the projection apparatus is capable of forming a transmission path with at least one other projection apparatus,
the projection portion projects a partial image of a projection image to a first projection region having an overlapping part with a projection region of the other projection apparatus forming the transmission path,
the processor is configured to, in response to the first communication portion receiving an enlarging or reducing instruction of a projection region including an enlarging or reducing ratio, calculate at least any of a direction or an amount of shifting of the first projection region based on the enlarging or reducing ratio and on positional information related to a position of the partial image in the projection image, and
the processor is configured to calculate at least any of the direction or the amount of shifting of the first projection region such that a ratio of the overlapping part in the first projection region is maintained before and after enlarging or reducing and shifting the first projection region based on the enlarging or reducing instruction.

2. The projection apparatus according to claim 1, further comprising:
a second communication portion,
wherein the first communication portion receives the enlarging or reducing instruction from a front stage of the projection apparatus in the transmission path, and
the processor is configured to perform a control of transmitting an instruction including the enlarging or reducing instruction to a rear stage of the projection apparatus in the transmission path from the second communication portion.

3. The projection apparatus according to claim 1,
wherein the processor is configured to control the projection portion to execute enlarging or reducing of the first projection region based on the enlarging or reducing instruction and shifting of the first projection region based on at least any of the calculated direction or the calculated amount of shifting.

4. The projection apparatus according to claim 1,
wherein the processor is configured to calculate the direction of shifting based on the positional information.

5. The projection apparatus according to claim 1,
wherein the processor is configured to calculate the amount of shifting based on the enlarging or reducing ratio and on the positional information.

6. The projection apparatus according to claim 1,
wherein the enlarging or reducing instruction includes an enlarging or reducing center, and
the processor is configured to calculate at least any of the direction or the amount of shifting of the first projection region based on the enlarging or reducing center.

7. The projection apparatus according to claim 1,
wherein the first communication portion receives instruction information related to projection, including an instruction value and type information of the instruction value, and
the processor is configured to control projection of the projection portion based on the type information and on the instruction value.

8. The projection apparatus according to claim 1,
wherein the processor is configured to, in a case where shifting of the first projection region by the calculated amount of shifting is unavailable in the projection portion, control the projection portion to execute shifting of the first projection region of an amount available in the projection portion and enlarging or reducing of the first projection region corresponding to shifting of the first projection region of the amount available in the projection portion.

9. The projection apparatus according to claim 8,
wherein the processor is configured to, in a case where shifting of the first projection region by the calculated amount of shifting is unavailable in the projection portion, perform a control of transmitting information related to the enlarging or reducing ratio of the projection region corresponding to shifting of the first projection region of the amount available in the projection portion to the other projection apparatus forming the transmission path.

10. The projection apparatus according to claim 9,
wherein the processor is configured to, in response to information related to an enlarging or reducing ratio different from the enlarging or reducing ratio of the enlarging or reducing instruction being received from the other projection apparatus forming the transmission path, control the projection portion to execute enlarging or reducing and shifting of the first projection region based on the information related to the different enlarging or reducing ratio.

11. The projection apparatus according to claim 1,
wherein the processor is configured to, in a case where shifting of the first projection region based on the enlarging or reducing instruction is unavailable, control the projection portion not to execute enlarging or reducing and shifting of the first projection region.

12. The projection apparatus according to claim 11,
wherein the processor is configured to:
perform a control of transmitting information related to availability of shifting of the first projection region based on the enlarging or reducing instruction to the other projection apparatus forming the transmission path; and
in response to a projection apparatus that is unavailable to perform shifting of the projection region based on the enlarging or reducing instruction being present among other projection apparatuses forming the transmission path based on the information related to the availability of shifting of the projection region based on the enlarging or reducing instruction and received from the other projection apparatuses forming the transmission path, control the projection portion not to execute enlarging or reducing and shifting of the first projection region.

13. The projection apparatus according to claim 1,
wherein the enlarging or reducing instruction includes an instruction for shifting resulting from enlarging or reducing of the projection region, and
the processor is configured to calculate at least any of the direction or the amount of shifting of the first projection region based on the instruction for shifting.

14. A projection system comprising:
a projection apparatus included in a plurality of projection apparatuses capable of forming a transmission path; and
a control device capable of transmitting projection image data representing a projection image and instruction information related to projection through the transmission path,
wherein a first projection apparatus included in the plurality of projection apparatuses projects a partial image of the projection image to a first projection region having an overlapping part with a projection region of the other projection apparatus forming the transmission path and, in response to an enlarging or reducing instruction of a projection region including an enlarging or reducing ratio being received, calculates at least any of a direction or an amount of shifting of the first projection region based on the enlarging or reducing ratio and on positional information related to a position of the partial image in the projection image, and
the first projection apparatus calculates at least any of the direction or the amount of shifting of the first projection region such that a ratio of the overlapping part in the first projection region is maintained before and after enlarging or reducing and shifting the first projection region based on the enlarging or reducing instruction.

15. The projection system according to claim 14,
wherein the control device is capable of transmitting the instruction information by issuing an interrupt during transmission of the projection image data.

16. The projection system according to claim 14,
wherein the control device transmits the instruction information by issuing an interrupt in accordance with a transmission state of the projection image data being transmitted.

17. A control method of a projection apparatus including a projection portion, a processor, and a first communication portion and being capable of forming a transmission path with at least one another projection apparatus,
the projection portion projecting a partial image of a projection image to a first projection region having an overlapping part with a projection region of the other projection apparatus forming the transmission path,
the method comprising:
calculating, in response to the first communication portion receiving an enlarging or reducing instruction of a projection region including an enlarging or reducing ratio, at least any of a direction or an amount of shifting of the first projection region via the processor based on the enlarging or reducing ratio and on positional information related to a position of the partial image in the projection image; and
calculating at least any of the direction or the amount of shifting of the first projection region such that a ratio of the overlapping part in the first projection region is maintained before and after enlarging or reducing and shifting the first projection region based on the enlarging or reducing instruction.

18. A non-transitory computer-readable storage medium storing a control program of a projection apparatus including a projection portion, a processor, and a first communication portion and being capable of forming a transmission path with at least one another projection apparatus,
the projection portion projecting a partial image of a projection image to a first projection region having an overlapping part with a projection region of the other projection apparatus forming the transmission path,
the program causing the processor to execute a process comprising:
calculating, in response to the first communication portion receiving an enlarging or reducing instruction of a projection region including an enlarging or reducing ratio, at least any of a direction or an amount of shifting of the first projection region based on the enlarging or reducing ratio and on positional information related to a position of the partial image in the projection image; and
calculating at least any of the direction or the amount of shifting of the first projection region such that a ratio of the overlapping part in the first projection region is maintained before and after enlarging or reducing and shifting the first projection region based on the enlarging or reducing instruction.
